(19) United States
(12) Patent Application Publication
(10) Pub. No.: US 2021/0350396 A1
(43) Pub. Date: Nov. 11, 2021

(54) SYSTEM AND METHOD FOR ANALYZING AND DISPLAYING STATISTICAL DATA GEOGRAPHICALLY

(71) Applicant: University of Miami, Miami, FL (US)

(72) Inventors: Raymond R. BALISE, Miami, FL (US); Layla BOUZOUBAA, Miami, FL (US)

(21) Appl. No.: 17/273,704

(22) PCT Filed: Sep. 6, 2019
(86) PCT No.: PCT/US2019/050098

§ 371 Date: Mar. 4, 2021

Related U.S. Application Data
(60) Provisional application No. 62/727,974, filed on Sep. 6, 2018.

(51) Int. Cl. G06Q 30/02; G06T 11/00; G06F 16/29

(52) U.S. Cl. CPC G06Q 30/0205; G06T 2200/24; G06F 16/29; G06T 11/00

(57) ABSTRACT

Systems and methods are disclosed herein for integration distinct data sets to provide a multidimensional view of a phenomenon of interest. For example, a method is disclosed comprising obtaining at least one first characteristic value associated with a first geographically defined area of a plurality of geographically defined areas and a plurality of second characteristic values each associated with a census tract of a plurality of census tracts; assigning census tracts to the first geographically defined area when the census tracts lie completely within the first geographically defined area; identifying one or more census tracts of the plurality of census tracts that intersect the first geographically defined area; and assigning the identified one or more census tracts to the first geographically defined area based on a comparison of a sum of the second characteristic values of the identified one or more census tracts against the at least one first characteristic value of the first geographically defined area.

### INTRODUCTION

This disclosure relates to integration of independent data sets to provide a multidimensional view of a phenomenon of interest, such as cancer. The disclosed system and methods enables data integration from multiple, often unrelated, sources simultaneously. More specifically, this disclosure describes systems and methods that leverages US census tracts in the geographical definitions of areas of interest such as neighborhoods, towns, cities, etc.

This application claims priority to U.S. Provisional Application No. 62/727,974, filed on Sep. 6, 2018, entitled “SYSTEMS AND METHODS TO VISUALIZE AND ANALYZE CANCER RISK FACTORS,” the contents of which are hereby incorporated by reference in their entirety.

### BRIEF DESCRIPTION OF THE DRAWINGS

Accordingly, systems and methods are disclosed for integration distinct data sets to provide a multidimensional view of a phenomenon of interest. In one aspect, a method is disclosed that comprises obtaining at least one first characteristic value associated with a first geographically defined area of a plurality of geographically defined areas and a plurality of second characteristic values each associated with a census tract of a plurality of census tracts, and assigning census tracts to the first geographically defined area when the census tracts lie completely within the first geographically defined area. The method also includes identifying one or more census tracts of the plurality of census tracts that intersect the first geographically defined area, and assigning the identified one or more census tracts to the first geographically defined area based on a comparison of a sum of the second characteristic values of the identified one or more census tracts against the at least one first characteristic value of the first geographically defined area.

In another aspect, a system is disclosed for integration of distinct data sets to provide a multidimensional view of a phenomenon of interest. The system comprises at least one database storing a plurality of first characteristic values associated with a plurality of geographically defined areas and a second characteristic values each associated with a plurality of census tracts, and at least one processor coupled to the at least one memory storing instructions for analyzing and processing the data. The at least one processor configured to execute the instructions to obtain at least one first characteristic value associated with a first geographically defined area of the plurality of geographically defined areas and a plurality of second characteristic values each associated with a census tract of the plurality of census tracts, and assign census tracts to the first geographically defined area when the census tracts lie completely within the first geographically defined area. The at least one processor is also configured to identify one or more census tracts of the plurality of census tracts that intersect the first geographically defined area, and assign the identified one or more census tracts to the first geographically defined area based on a comparison of a sum of the second characteristic values of the identified one or more census tracts against the at least one first characteristic value of the first geographically defined area.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

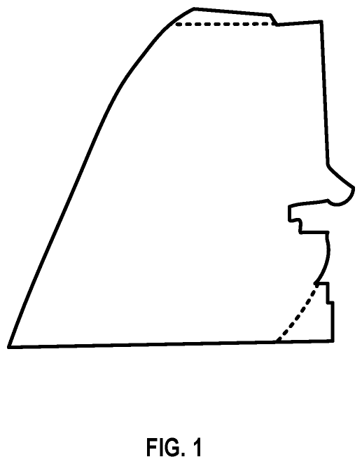

FIG. 1 is a graphical representation of a geographically defined place (e.g., a village) and the census tracts which fall completely within it;

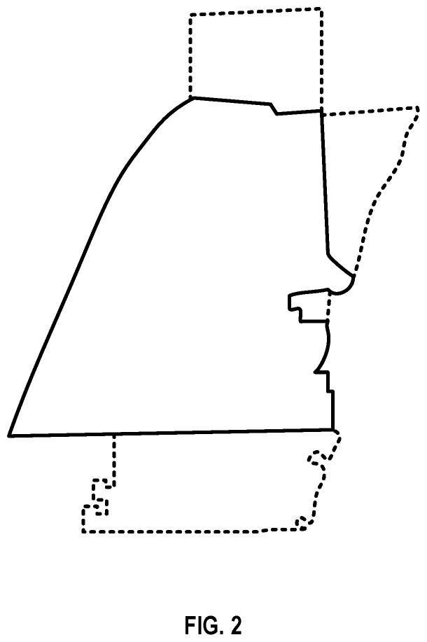

FIG. 2 is a graphical representation of the geographically defined place from FIG. 1 and the census tracts which need to be included to obtain complete coverage of the geographically defined place;

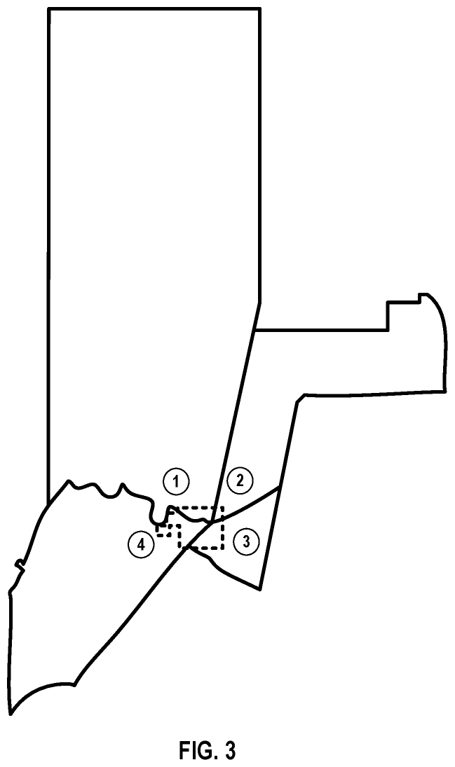

FIG. 3 is a graphical representation of a geographically defined place (e.g., a village) and the four census tracts within which it falls;

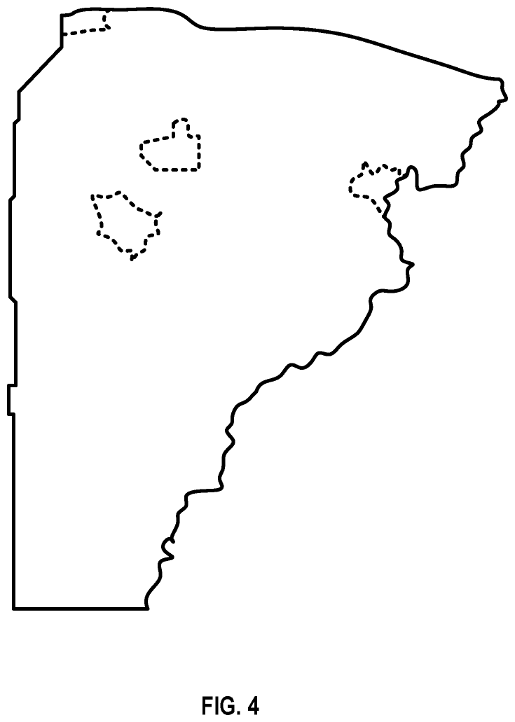

FIG. 4 i is a graphical representation of a four geographically defined places (e.g., villages) and the single census tract within which all four geographically defined places are contained; and

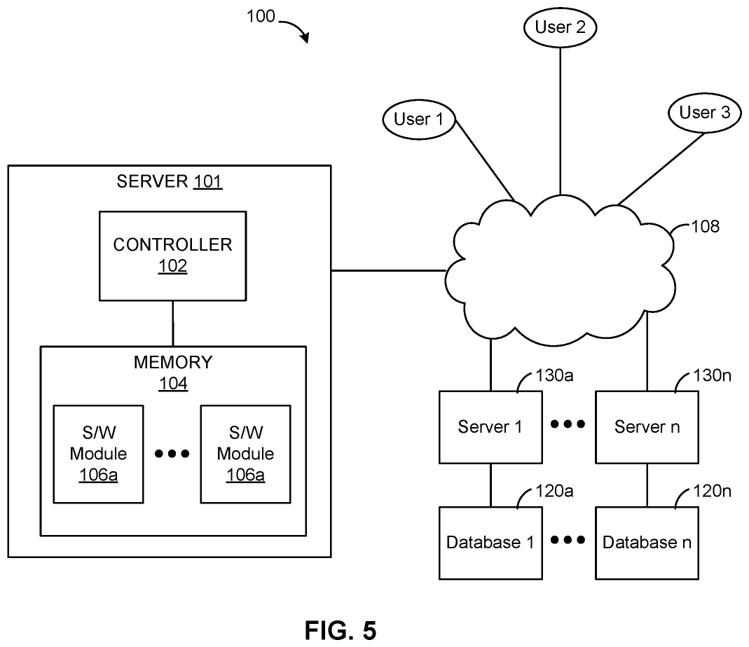

FIG. 5 is a functional block diagram of a system for performing the functions of the methods and processes disclosed herein.

### DETAILED DESCRIPTION

This disclosure relates to systems and methods for the integration of independent data sets to provide a multidimensional view of a phenomenon of interest, such as cancer. The disclosed system and methods enable data integration from multiple, often unrelated, sources simultaneously. In one embodiment the methods leverage U.S. census tracts in the geographical definitions of areas of interest such as neighborhoods, towns, cities, etc. Census tracts are defined by the U.S. Census Bureau. They are small geographic entities, which are relatively permanent statistical subdivisions of a county. Many data sources are keyed or organized on a census tract basis. For example, one aspect of the Florida Cancer Data System is that it provides every reportable case of cancer correlated to US census tract. Further, the U.S. Census Bureau has many data bases which are organized or accessible by census tract, for example, the American Community Survey (ACS). In order to view and analyze such data in terms of other geographically defined areas, there is a need to correlate between census tracts and other geographically defined areas. Though the primary example described herein utilizes census tracts, other geographically defined areas can also be used.

FIG. 1 is a graphical representation of a geographically defined place (e.g., a village) and the census tracts which fall completely within it. The solid outer line represents the geographically defined place. The space between the solid line and the dashed lines represents area of the geographically defined place that are not encompassed by the four census tracts that fall completely within the geographically defined place.

A hierarchy of geographic areas can be used. For example, the hierarchy can range from State, to County, to Census Defined Places (e.g., City, Town, Village) and to Neighborhoods defined within a city. The hierarchy can be used to translate data between geographically defined places.

FIG. 2 is a graphical representation of the geographically defined place from FIG. 1 and the census tracts which need to be included (assigned) (in addition to the four which fall completely within the geographically defined place) to obtain complete coverage of the geographically defined place. In this example three additional census tracts intersect the geographically defined area (they are only partially within the geographically defined area). The census tracts which need to be included to complete the coverage are shown in dotted lines. The geographically defined place has one or more characteristics associated with it. In one example, the place is a village and the characteristic is the population of the village. Each of the census tracts also has a population associated with it. Including all of the census tracts that cross the boundary of a place overestimates population count for the village because it includes population that is outside of the village. In one example the total population of all of the census tracts that cross the boundary of the geographically defined place is over 28,000. However, the population of the geographically defined place is known to be 18,917 (for example from the U.S. Census Bureau's data statistics on Census Defined places). The total population of the census tracts which fall completely within the boundary of the geographically defined place is 16,986.

In one embodiment the system assigns census tracts which intersect the boundary of more than one geographically defined place by looking to which place gets closest to its actual population by including the intersecting census tract and which place contains a majority of the population of that census tract. For example, a best fit algorithm can be used. Once the census blocks are assigned to a geographically defined place, the data associated with those census blocks can be associated with that geographically defined place.

FIG. 3 is a graphical representation of a geographically defined place (e.g., a village) indicated with a dotted line and the four census tracts (shown with solid lines) within which it falls. This represents another issue in assigning census tracts to a geographically defined place. In this example, the geographically defined place has a very small population and falls within four census tracts numbered 1-4. The four census tracts have a population in the thousands. In this case, no census tract is assigned to the geographically defined place. This figure represents the problem where the population is so low for a geographically defined place that reporting certain types of information, for example, medical information, may violate the privacy of the residents.

FIG. 4 i is a graphical representation of a four geographically defined places (e.g., villages) shown with dotted lines and the single census tract within which all four geographically defined places are contained. This issue is addressed by assigning the census tract to one of the four places and removing the other three. In one embodiment the census tract is assigned to the geographically defined place with the largest population.

FIG. 5 is a functional block diagram of a system for performing the functions of the methods and processes disclosed herein. The system 100 can have a server 101. The server 101 can perform one or more of the processes disclosed herein (e.g., described above and below). The server 101 can have a controller 102. The controller 102 can have a central processing unit (CPU) having one or more processors or microprocessors. In some other embodiments, the controller 102 can be a collection or group of distributed processors in a network or via cloud computing.

The server 101 can have a memory 104 communicatively coupled to the controller 102. The memory 104 can store data and other information. The memory 104 can further have one or more software modules 106. The software modules 106 are indicated as a software module 106a through software module 106n separated by the ellipsis, indicating the presence of a plurality software modules 106. The software modules 106 can include instructions that when executed by the controller 102 perform one or more of the processes disclosed herein.

In some embodiments, the server 101 can be coupled to a wide area network 108. The wide area network can include the Internet. The wide area network 108 can provide connectivity to one or more servers 130 and related databases 120. The servers 130 are shown as server 130a through server 130n, separated by the ellipsis. Any number of servers 130 is possible. The databases 120 are shown as database 120a through database 120n, separated by the ellipsis. Any number of databases 120 is possible. The databases 120 can include the various databases described above.

The server 101 can provide a graphical user interface via, for example, the network 108. For example, one of the users of the system 100 can use a computing device having a mouse, keyboard, touchscreen, etc. to display and interact with the graphical user interface provided by the server 101. Users can access the user interface (e.g., with a home computer) to interact with the server 101 via the network 108. Those of skill will appreciate that the various illustrative functions, modules, displays, and algorithm steps described above in connection with the embodiments disclosed herein can often be implemented as electronic hardware, computer software, or combinations of both. To clearly illustrate this interchangeability of hardware and software, various illustrative functions, modules, and steps have been described above generally in terms of their functionality. Whether such functionality is implemented as hardware or software depends upon the particular constraints imposed on the overall system. Skilled persons can implement the described functionality in varying ways for each particular system, but such implementation decisions should not be interpreted as causing a departure from the scope of the invention.

The various illustrative logical functions, displays, steps and modules described in connection with the embodiments disclosed herein can be implemented or performed with a processor, such as a general purpose processor, a multi-core processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, or microcontroller. A processor can also be implemented as a combination of computing devices, for example, a combination of a DSP and a microprocessor, a plurality of microprocessors, one or more microprocessors in conjunction with a DSP core, or any other such configuration.

Reference throughout this specification to “one embodiment” or “an embodiment” or “one example” or “an example” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, and algorithm operations described in connection with the embodiments disclosed herein may be implemented as electronic hardware, computer software, or combinations of both. To clearly illustrate this interchangeability of hardware and software, various illustrative components, blocks, modules, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present inventive concept.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), and electrically erasable programmable read-only memory (EEPROM) Additionally, the operations of a method or algorithm may reside as one or any combination or set of codes and/or instructions on a non-transitory processor-readable storage medium and/or computer-readable storage medium, which may be incorporated into a computer program product.

The previous description is provided to enable any person skilled in the art to practice the various aspects described herein. Various modifications to these aspects will be readily apparent to those skilled in the art, and the generic principles defined herein may be applied to other aspects.

What is claimed is:

1. A method for integrating distinct data sets to provide a multidimensional view of a phenomenon of interest, the method comprising:
obtaining at least one first characteristic value associated with a first geographically defined area of a plurality of geographically defined areas and a plurality of second characteristic values each associated with a census tract of a plurality of census tracts;
assigning census tracts to the first geographically defined area when the census tracts lie completely within the first geographically defined area;
identifying one or more census tracts of the plurality of census tracts that intersect the first geographically defined area; and
assigning the identified one or more census tracts to the first geographically defined area based on a comparison of a sum of the second characteristic values of the identified one or more census tracts against the at least one first characteristic value of the first geographically defined area.

2. The method of claim 1, further comprising, when a second geographically defined area, having a first characteristic value, and a third geographically defined area, having a first characteristic value, lie completely within a census tract of the plurality of census tracts, assigning that census tract to the second geographically defined area or the third geographically defined area based on a comparison the first characteristic values of the second geographically defined area and the third geographically defined area.

3. The method of claim 1, further comprising removing the first geographically defined area when the at least one first characteristic value associated with the first geographically defined area is below a threshold value.

4. The method of claim 1, wherein assigning the identified one or more census tracts is based on a best fit algorithm.

5. The method of claim 1, further comprising determining whether the census tract falls completely within the first geographically defined area.

6. The method of claim 4, wherein the first geographically defined area comprises a boundary, and wherein identifying one or more census tracts of the plurality of census tracts intersect the first geographically defined area is based on determining that the one or more census tracts intersect the boundary of the first geographically defined area.

7. The method of claim 1, wherein the first geographically defined area comprises a boundary, and wherein determining whether one or more census tracts fall completely within the first geographically defined area is based on determining that the one or more census tracts is contained within the boundary of the first.

8. The method of claim 1, wherein a plurality of geographically defined areas, including the first geographically defined area, each has an associated at least one first characteristic value, wherein assigning the identified one or more census tracts to the first geographically defined area further comprises a comparison of a sum of second characteristic values of a subset of census tracts against a respective first characteristic value of a respective geographically defined area of the plurality of geographically defined areas to which the subset of census tracts is assigned.

9. The method of claim 8, wherein assigning the subset of census tracts is based on a best fit algorithm of the comparisons for each of the geographically defined areas.

10. The method of claim 1, wherein the at least one first characteristic value is a population value associated with the first geographically defined area and the plurality of second characteristic values are a plurality of population values associated with the plurality of census tracts.

11. A system for integration of distinct data sets to provide a multidimensional view of a phenomenon of interest, the system comprising
at least one database storing a plurality of first characteristic values associated with a plurality of geographically defined areas and a second characteristic values each associated with a plurality of census tracts; and
at least one processor coupled to the at least one memory storing instructions for analyzing and processing the data, the at least one processor configured to execute the instructions to:
obtain at least one first characteristic value associated with a first geographically defined area of the plurality of geographically defined areas and a plurality of second characteristic values each associated with a census tract of the plurality of census tracts,
assign census tracts to the first geographically defined area when the census tracts lie completely within the first geographically defined area,
identify one or more census tracts of the plurality of census tracts that intersect the first geographically defined area, and
assign the identified one or more census tracts to the first geographically defined area based on a comparison of a sum of the second characteristic values of the identified one or more census tracts against the at least one first characteristic value of the first geographically defined area.

12. The system of claim 11, wherein the at least one processor is further configured to, when a second geographically defined area, having a first characteristic value, and a third geographically defined area, having a first characteristic value, lie completely within a census tract of the plurality of census tracts, assign that census tract to the second geographically defined area or the third geographically defined area based on a comparison the first characteristic values of the second geographically defined area and the third geographically defined area.

13. The system of claim 11, wherein the at least one processor is further configured to remove the first geographically defined area when the at least one first characteristic value associated with the first geographically defined area is below a threshold value.

14. The system of claim 11, wherein the at least one processor is further configured to determine whether the first census tract falls completely within the first geographically defined area.

15. The system of claim 11, wherein the at least one first characteristic value is a population value associated with the first geographically defined area and the plurality of second characteristic values are a plurality of population values associated with the plurality of census tracts.
